(19) United States
(12) Patent Application Publication
(10) Pub. No.: US 2005/0173059 A1
(43) Pub. Date: Aug. 11, 2005

(54) Methods of making a multi-well test plate having an adhesively secured transparent bottom panel

(75) Inventors: Ronald D. Ringleben, Fairport, NY (US); Scott A. Harris, Rochester, NY (US)

Correspondence Address: WOOD, HERRON & EVANS, LLP, 2700 CAREW TOWER, 441 VINE STREET, CINCINNATI, OH, 45202, US

(73) Assignee: Nalge Nunc International Corporation, Rochester, NY (US)

(21) Appl. No.: 10/776,785

(22) Filed: Feb. 11, 2004

(51) Int. Cl. B32B 31/00

(52) U.S. Cl. 156/291; 156/292

(57) ABSTRACT

Methods of making a multi-well test plate including an upper frame portion and a transparent panel secured to a lower side of the upper frame portion with adhesive. The upper frame portion includes a plurality of walls defining adjacent wells for receiving assay samples. The adhesive may be applied to either the transparent panel or the upper frame portion by various techniques including, but not limited to, transfer printing, robotic dispensing, silk screening, flexographic printing, and pad printing.

### FIELD OF THE INVENTION

The invention generally relates to multi-well test plates for assaying liquid samples and, more particularly, to methods of making a multi-well test plate having a panel adhesively bonded to a framework defining test wells for containing the liquid samples.

### BACKGROUND OF THE INVENTION

Multi-well test plates or micro-plates are well known in scientific areas such as biotechnology, for use in the detection and measurement of substances present in translucent liquid samples. Generally, the light absorbence characteristics of the sample are measured through one or more spectroscopy procedures. Typically, a framework of test wells in the test plate is open at the top for receiving the liquid samples and is closed with a transparent bottom that allows light radiation penetration in a wavelength region necessary for a particular study. These studies, commonly referred to assays, may include drug concentration assays, drug metabolite assays, enzyme activity assays, enzyme cofactor assays, fluorescent probe excitations or emissions, DNA spectral shifts or DNA and protein concentration measurements, as well as many other studies.

When applying a panel to the bottom of the framework, for example, it has been difficult to achieve a seal in surrounding relationship to each individual test well. Conventional manufacturing methods involving an adhesive securement of the transparent panel to the test well framework may result in inadequate adhesion, inadequate sealing around the bottom of each well, adhesive migration into the test wells or other problems. Adhesive migration into the test wells is particularly troublesome as the presence of the adhesive in on the work area of the optical surface may potentially alter the assay results. Moreover, the presence of adhesive in these work areas may interfere with the creation and reading of microassays, cell adhesion and growth, and binding and assaying of nucleic acids, proteins, etc. among other artifacts.

What is needed, therefore, is a method of applying adhesive between an upper frame structure and a transparent panel to form a test plate that that does not contact the work area of the optical surface thereby preventing adhesive contamination.

### SUMMARY OF THE INVENTION

In accordance with the invention, a method is provided for making a multi-well test plate that includes applying an adhesive to either the transparent panel or the upper frame portion in a configuration corresponding to a pattern defining test plate wells and contacting the transparent panel with the upper frame portion such that the adhesive is disposed between the transparent panel and the upper frame portion. The adhesive is then cured to adhesively bond the upper frame portion and the transparent panel. The adhesive may be applied by various techniques including, but not limited to, transfer printing, robotic dispensing with one or more channels, flexographic printing, silk screening, and pad printing. The adhesive is applied in a well-defined pattern and does not contaminate or contact the work areas on the optical surface of the transparent panel defined into test wells by the presence of the upper frame portion.

Additional objectives, advantages and features of the invention will become more readily apparent to those of ordinary skill in the art upon review of the following detailed description of the preferred embodiments, taken in conjunction with the accompanying drawings.

### BRIEF DESCRIPTION OF THE DRAWINGS

FIG. 1 is a perspective view of an upper frame portion of a multi-well test plate constructed in accordance with an embodiment of the invention.

FIG. 2 is a top view of the upper frame portion of the multi-well test plate of FIG. 1.

FIG. 3 is a cross-sectional view taken along line 3-3 of FIG. 2.

FIG. 4 is a top view of the adhesive pattern applied either to the transparent panel or to the upper frame portion.

FIG. 5 is a schematic, perspective view showing the upper frame portion being applied to the transparent panel with the adhesive pattern of FIG. 4.

FIGS. 6A-C are schematic, perspective views depicting a sequence for applying adhesive to the upper frame portion using a transfer printing method.

FIG. 7 is a schematic, perspective view depicting adhesive application to the inverted upper frame portion using robotic dispensing with a single channel dispenser.

FIG. 8 is a schematic, perspective view similar to FIG. 7 depicting adhesive application to the transparent panel using robotic dispensing with a single channel dispenser.

FIG. 9 is a schematic, perspective view depicting a robotic dispensing method with multiple channels for applying adhesive to the transparent panel.

FIG. 10 is an enlarged, perspective view similar to FIG. 9 depicting a robotic dispensing method for applying adhesive to the upper frame portion.

FIG. 11 is a schematic, perspective view depicting adhesive application to the transparent panel using flexography.

FIG. 12 is a schematic, perspective view similar to FIG. 11 depicting adhesive application to the upper frame portion using flexography.

FIG. 13 is a schematic, perspective view depicting adhesive application to the upper frame portion using pad printing.

FIG. 14 is a schematic, perspective view similar to FIG. 13 depicting adhesive application to the transparent panel using pad printing.

FIG. 15 is a schematic, perspective view depicting adhesive application to the upper frame portion using silk screening.

### DETAILED DESCRIPTION OF THE PREFERRED EMBODIMENTS

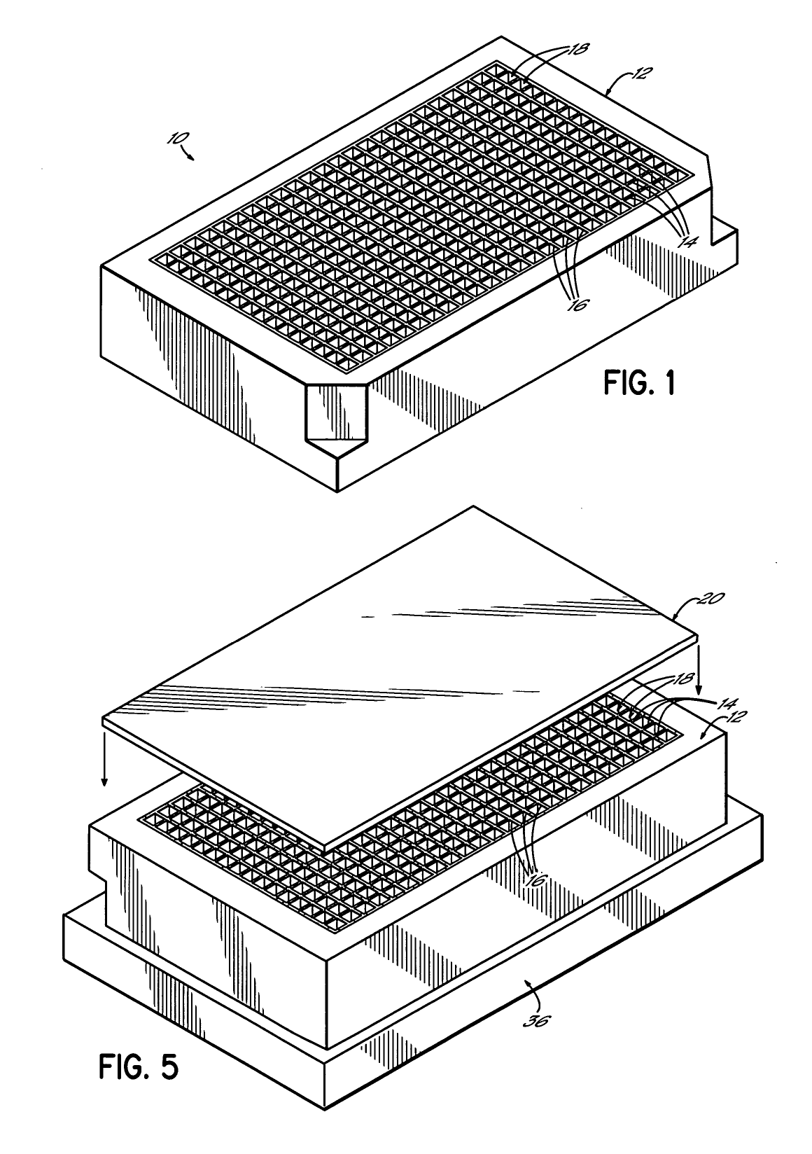

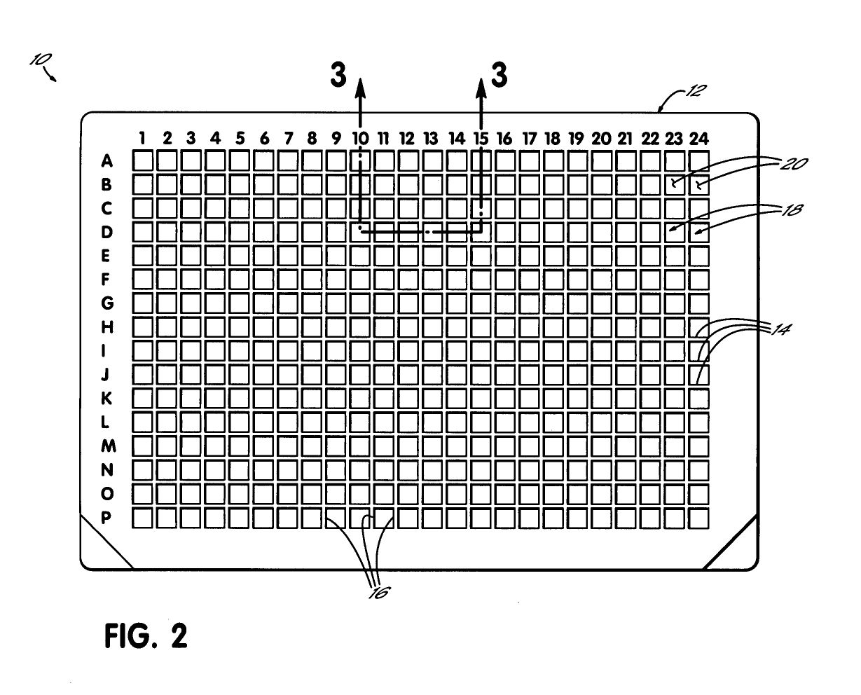

Referring first to FIGS. 1-3, a multi-well test plate 10 constructed in accordance with one preferred embodiment of the invention generally comprises an upper frame portion 12 having a plurality of walls 14, 16. Upper frame portion 12 is preferably formed from a polymer, such as polystyrene, and is preferably opaque. Other polymer resins suitable for forming upper frame portion 12 include, but are not limited to, polyolefins (e.g., polypropylene, high density polyethylene, and polymethylpentene), cyclic olefin polymers and copolymers, acrylics, polyesters, polycarbonate, polystyrene, high impact polystyrene, and polysulfone. Depending on the intended use of test plate 10, upper frame portion 12 can be transparent, translucent, or opaque. In specific embodiments, the upper frame portion 12 may be white, which provides advantageous light reflective properties, or black, which has advantageous light absorptive properties. Walls 14, 16 define independent wells 18 for receiving liquid assay samples in which each well 18 includes a working area on the optical surface of test plate 10. The specific embodiment shown and described herein includes 384 square wells 18, however, it should be understood that a greater or fewer number of wells may be used in a multi-well test plate constructed in accordance with the inventive concepts. Also, the square wells shown and described herein are also for illustrative purposes and may be substituted with wells of various shapes, including circular wells or other polygonal-shaped wells.

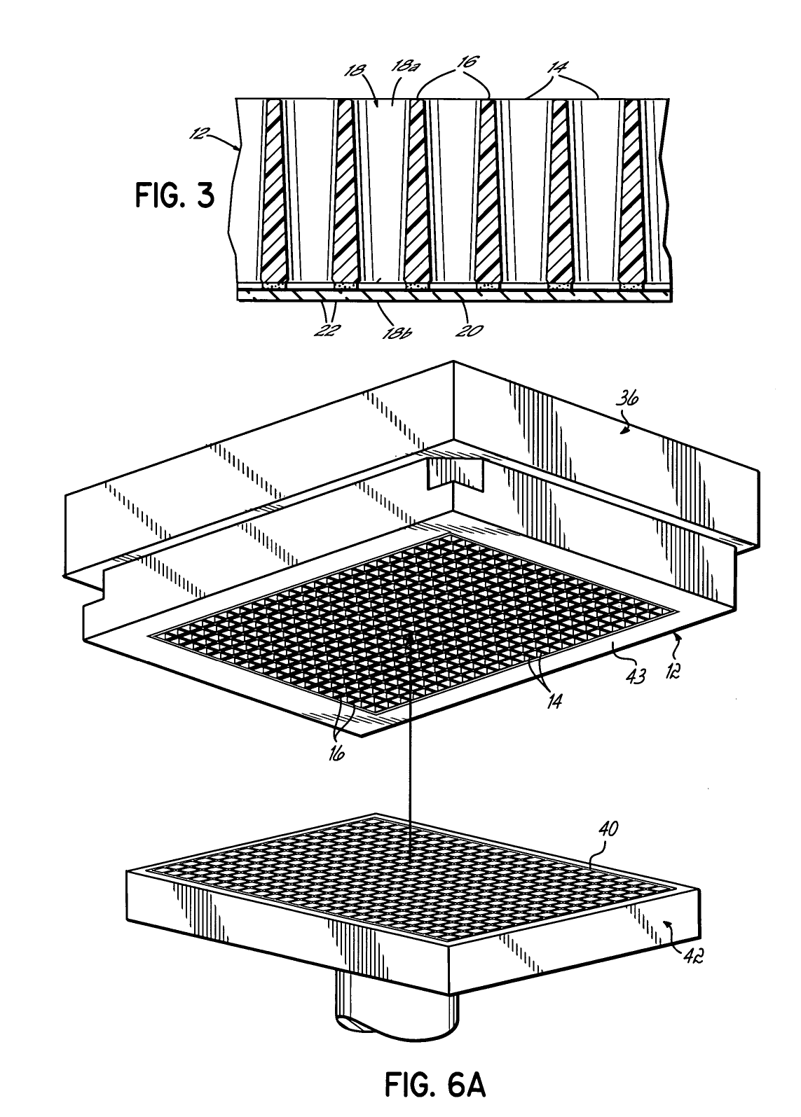

With reference to FIGS. 3-5, upper frame portion 12 is secured to a transparent panel 20 by a pattern of adhesive 22, which is illustrated as a grid pattern of adhesive 22. Transparent panel 20 may be composed of any suitable transparent material including, but not limited to, glass, coated glass (e.g., aminopropylsilane treated glass), polymers, surface-treated polymers (e.g., oxygen plasma treated polystyrene), and sapphire. The layer of adhesive 22 is positioned in circumscribed, surrounding relation to each well 18 between walls 14, 16 and transparent panel 20. This must be accomplished while achieving sufficient adhesion between walls 14, 16 and transparent panel 20, but without allowing adhesive 22 to squeeze into wells 18 as transparent panel 20 and upper frame portion 12 are united, as further described below.

In one embodiment, adhesive 22 is an acrylated urethane adhesive that is curable by exposure to ultraviolet (UV) and/or visible (V) light. Among the suitable commercially available adhesives are Loctite® adhesive 3211 and Loctite® adhesive 3321, which exhibit UV/V light curability, thixotropic characteristics, transparency, no off-gassing after curing, water insolubility, non-autofluorescence, a viscosity preferably greater than about 5,000 centipoise (cps), non-cytotoxicity, the ability to release completely from an applicator, and the affinity to transfer completely to a surface. Other heat curable or infrared curable adhesives or epoxies may be suitable for use in the invention. Although an exaggerated thickness is shown in FIG. 3 for clarity, adhesive layer 22 is applied in a thickness ranging from about 0.0005″ to about 0.005″ in certain embodiments of the invention. In other embodiment, the adhesive thickness ranges from about 0.002″ to about 0.004″. The thickness of transparent panel 20 may be within a range of thicknesses of about 0.005″ to about 0.040″ and, typically, is about 0.006″. When the adhesive 22 is applied, for example, in a grid pattern as described below, an edgewise gap of about 0.003″ to about 0.005″ is left on each side of the bottom of each wall 14, 16 so as to accommodate squeeze-out of the adhesive 22 as transparent panel 20 and upper frame portion 12 are contacted.

With continued reference to FIGS. 3-5, the transparent panel 20 is applied to upper frame portion 12 while ensuring that the perimeters of the upper frame portion 12 and the transparent panel 20 are substantially registered. Alternatively, the adhesive 22 may be provided on the transparent panel 20 and the upper frame portion 12, while substantially registering lower ends of walls 14, 16 with the lines of adhesive 22a, 22b, 22c, moved to contact the transparent panel 20. Regardless of the original location of the adhesive 22 and the specific assembly technique, the adhesive 22 in the assembled structure defining multi-well test plate 10 resides between the lower ends of the walls of walls 14,16 and the lines of adhesive 22a, 22b, 22c. Before adhesive 22 is applied to the upper frame portion 12 or the confronting optical surface of the transparent panel 20, as may be appropriate, either or both of these surfaces may be modified with a surface treatment, such as a corona discharge, plasma, or ultraviolet light exposure, that enhances the strength of adhesive bonding.

The adhesive 22 is cured to provide a permanent bond or, optionally, a bond capable of being controllably and selectively released at a later time. If the adhesive 22 is light curable, ultraviolet and/or visible light from an electrode or electrode-less lamp, such as a xenon lamp or a mercury vapor lamp, is directed at the adhesive 22 through transparent panel 20 or through upper frame portion 12 for a duration and at a power effective to cure adhesive lines 22a, 22b, 22c.

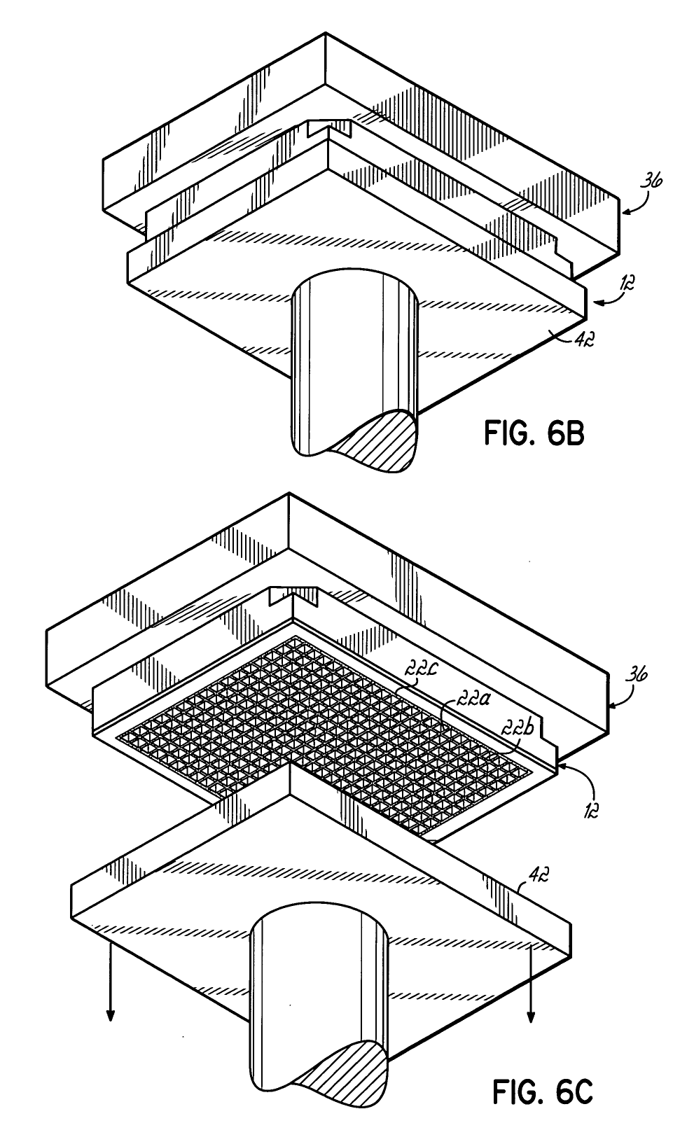

With reference to FIG. 6A-C and in accordance with an alternative embodiment of the invention, adhesive 22 may be applied to the lower ends of walls 14, 16 or the upper frame portion 12 using techniques of transfer printing. With specific reference to FIG. 6A, an adhesive image, generally indicated by reference numeral 40, arranged in a pattern is printed onto a printing block 42 by a conventional technique, such as by silk screening by emulsion on fabric, emulsion on wire mesh or emulsion on photo-etched metal. The printing block 42 is positioned relative to an underside 43 of upper frame portion 12, which is held stationary by a fixture 36 that may apply suction to the upper frame portion 12, so that the adhesive image 40 is aligned or registered with the lower ends of walls 14, 16.

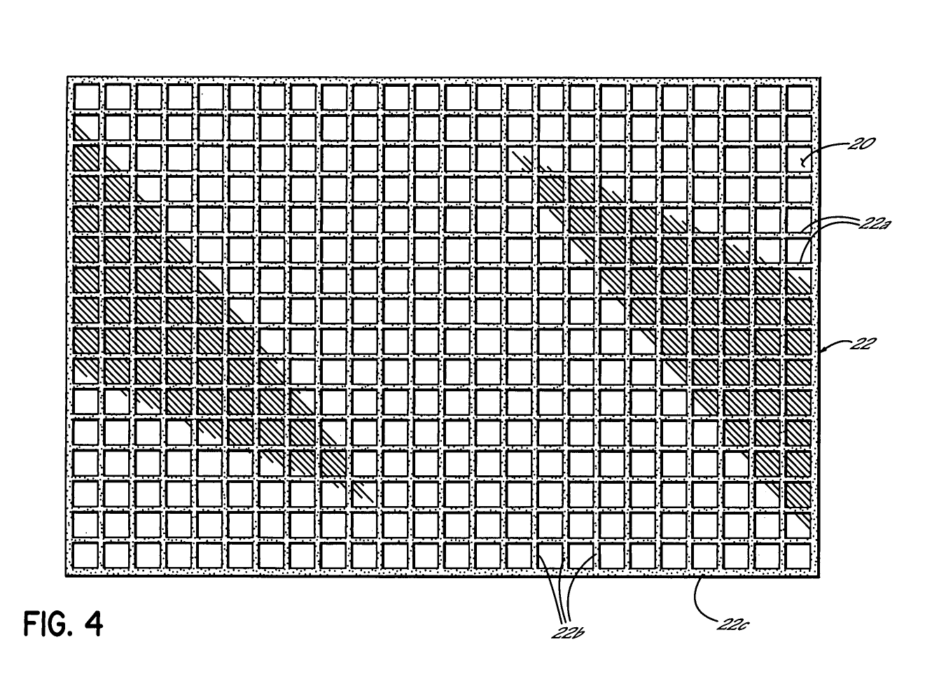

With specific reference to FIGS. 6A and 6B, the printing block 42 is raised toward and placed in pressure contact with the upper frame portion 12. With specific reference to FIG. 6C, the pattern of adhesive 22 (FIG. 4) is transferred as adhesive lines 22a, 22b, 22c to the lower ends of walls 14, 16 as the printing block 42 is lowered away from the upper frame portion 12. Subsequently, the upper frame portion 12 and transparent panel 20 are contacted, as shown in FIG. 5, and the adhesive 22 is cured to adhesively bond the upper frame portion 12 with the transparent panel 20. The invention contemplates that, equivalently, the adhesive image 40 may be applied by transfer printing to the transparent panel 20, which is then united with the upper frame portion 12 by the pattern of adhesive 22 registered with the lower ends of the walls 14, 16, and the transferred adhesive 22 is cured to form multi-well test plate 10.

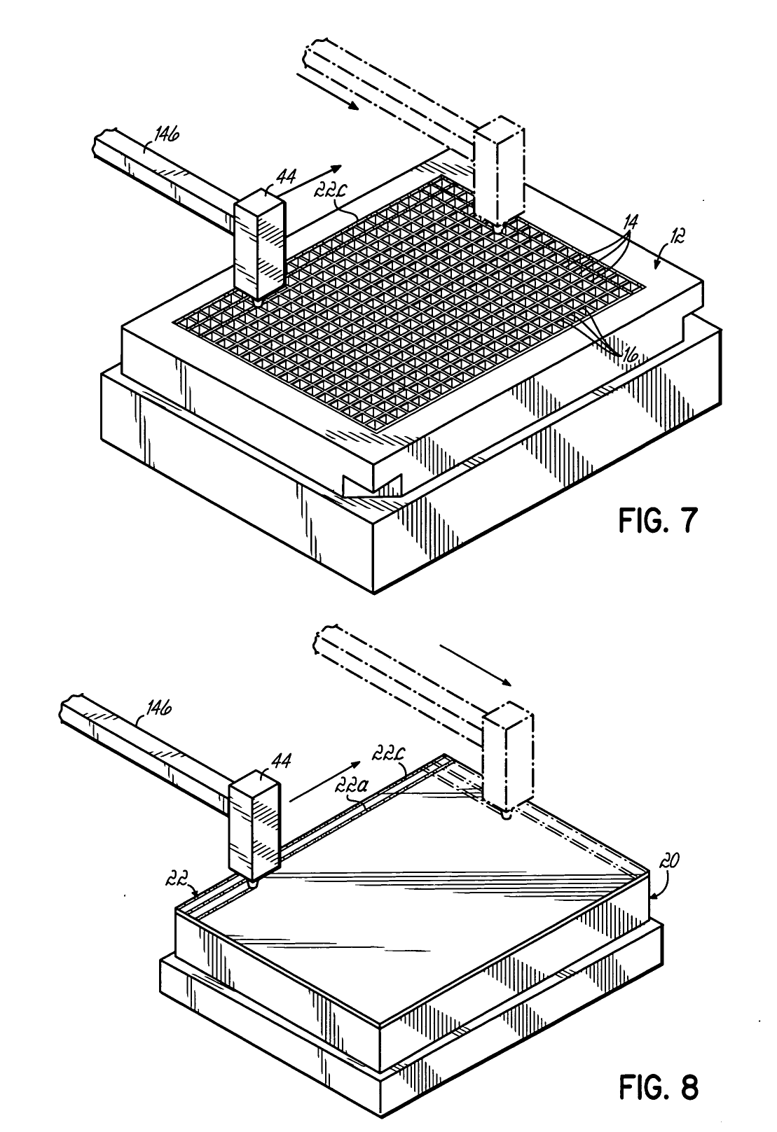

With reference to FIG. 7 and in accordance with an alternative embodiment of the invention, the pattern of adhesive 22 may be applied as a series of beads to the underside 43 of the upper frame portion 12 using techniques of robotic dispensing. To that end, an adhesive dispenser 44 is attached to the free end of a robotic arm 46, which is capable of moving at least in a plane substantially parallel to a plane containing the lower ends of intersecting walls 14, 16 (FIG. 1) and, preferably, in three dimensions. The adhesive dispenser 44 is configured to dispense adhesive 22 at a regulated flow rate from a discharge outlet, which is positioned proximate to the upper frame portion 12 with a non-contacting relationship. The adhesive dispenser 44 is in fluid communication with a feed line coupled with a conventional adhesive source (not shown). The programmed movement of the robotic arm 46 is coordinated with the dispensing of adhesive 22 from the adhesive dispenser 44 for applying the adhesive lines 22a, 22b, 22c characterizing the pattern of adhesive 22 in a non-contacting manner to the bottom of each wall 14, 16 of upper frame portion 12. The upper frame portion 12 and the transparent panel 20 are contacted and the adhesive 22 is cured to adhesively bond the upper frame portion 12 with the transparent panel 20 to form multi-well test plate 10.

With reference to FIG. 8 and in accordance with another alternative embodiment of the invention, the pattern of adhesive 22 may be applied as a series or grid of beads using adhesive dispenser 44 and robotic arm 46 to the transparent panel 20 rather than to the upper frame portion 12. The transparent panel 20 is contacted with the upper frame portion 12 in an aligned relationship to register the bottoms of walls 14, 16 with the pattern of adhesive 22, and the adhesive 22 is cured to affect an adhesive bond.

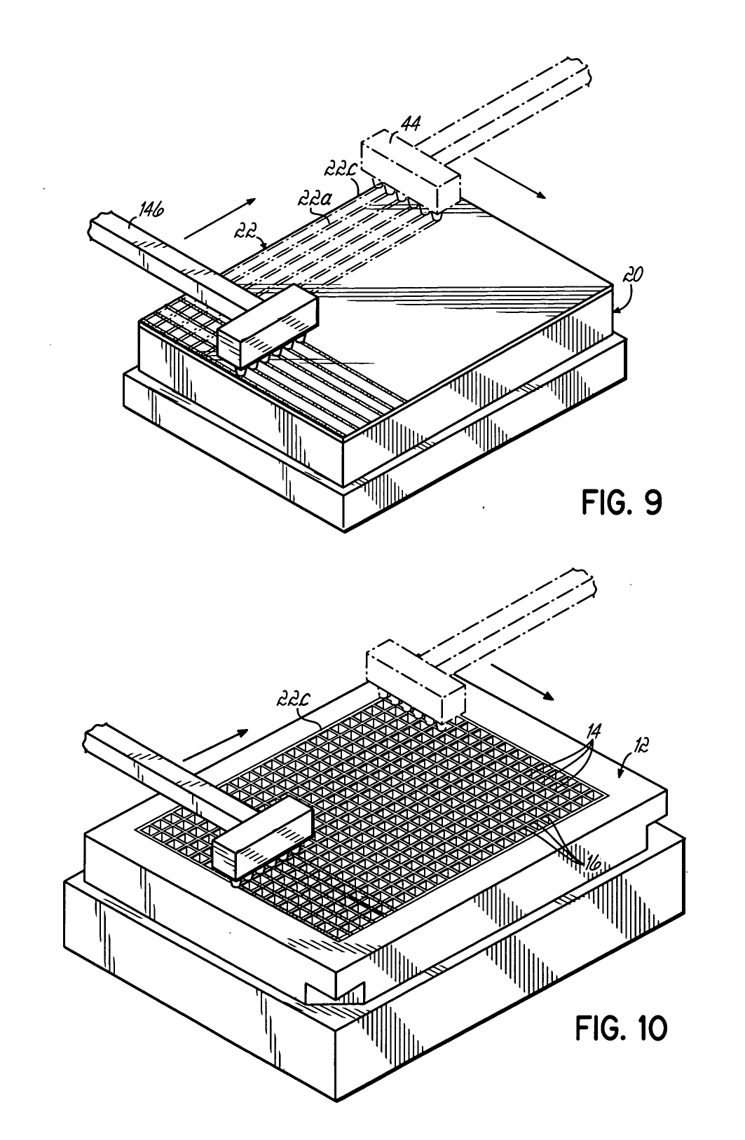

With reference to FIG. 9 and in accordance with an alternative embodiment of the invention, the pattern of adhesive 22 may be applied to the transparent panel 20 using a multi-channel method robotic dispensing process. To that end, a set of pens or dispense valves 48 is mechanically fixed to a movable support fixture 50 with an arrangement in a row that matches the spacing between adjacent adhesive lines 22a, 22b, 22c in the pattern of adhesive 22 (FIG. 6). Although six dispense valves 48 are shown in the exemplary embodiment, it is contemplated that any suitable number of dispense valves 48 may be supported from support fixture 50. Suitable dispense valves 48 are commercially available, for example, from Henkel Loctite Corporation (Rocky Hill, Conn.). The dispense valves 48 are in fluid communication with corresponding feed lines coupled with a conventional adhesive source (not shown). After adhesive 22 is applied, the upper frame portion 12 and transparent panel 20 are contacted with one another and the adhesive 22 is cured to adhesively bond the upper frame portion 12 and the transparent panel 20.

With reference to FIG. 10 and in accordance with yet another alternative embodiment of the invention, the set of dispense valves 48 may be used to apply the pattern of adhesive 22 (FIG. 6) to the transparent panel 20 rather than the upper frame portion 12. The upper frame portion 12 and transparent panel 20 are contacted and, thereafter, the adhesive 22 is cured to adhesively bond the upper frame portion 12 and the transparent panel 20.

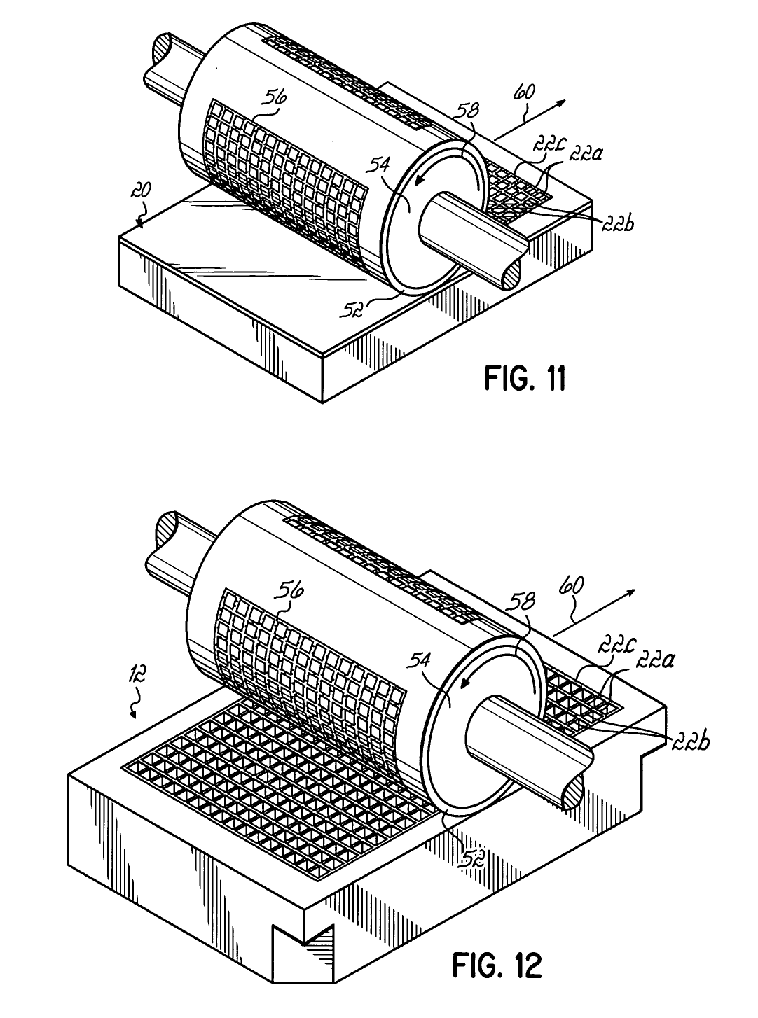

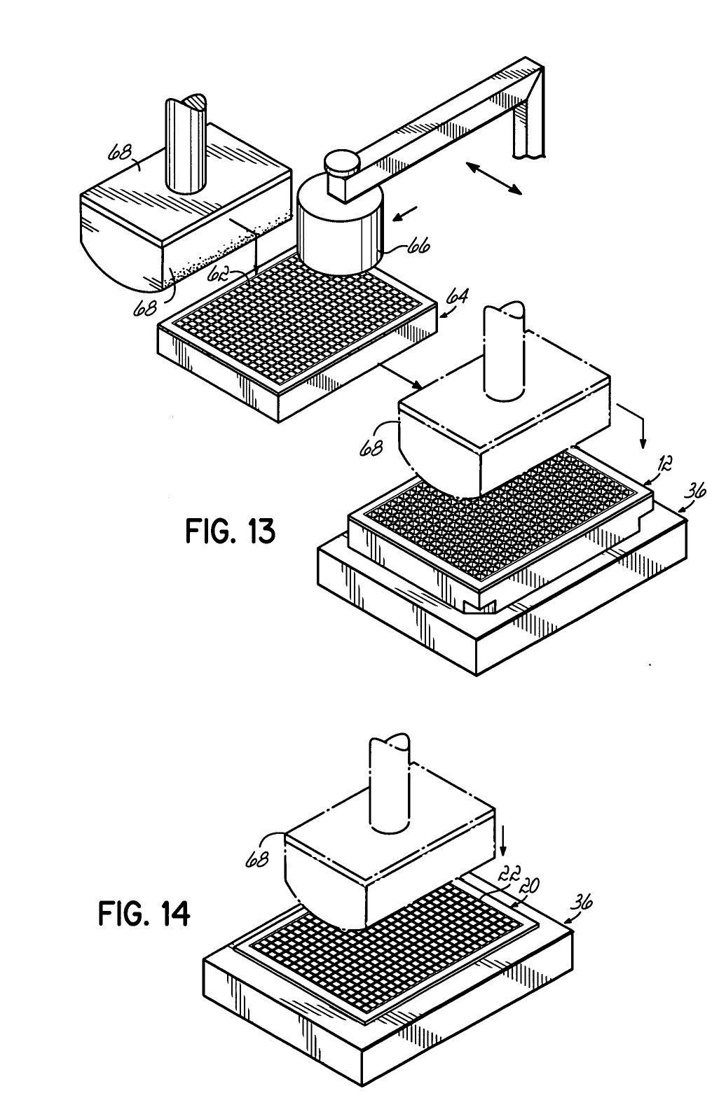

With reference to FIG. 11 and in accordance with yet another alternative embodiment of the invention, the enclosed grid pattern of adhesive 22 may be applied to the transparent panel 20 using techniques of flexographic printing or flexography. A resilient printing plate 52, typically made of rubber or polymer, covers the exterior of a rotatable cylindrical drum 54. The resilient printing plate 52 has a slightly-raised image, generally indicated by reference numeral 56, with a raised pattern arranged in a mirror image of the pattern of adhesive 22 to be applied to transparent panel 20 superimposed upon a recessed non-image area. The pattern may be created on resilient printing plate 52 by any conventional technique including, but not limited to, photolithography and chemical etching of a metallic plate used as a mold for the resilient printing plate 52, patterning photopolymerizable compositions, and laser engraving of a layer of rubber applied directly to drum 54.

The image 56 on resilient printing plate 52 includes raised lines that correlate with lines of adhesive 22a, 22b, 22c in the pattern of adhesive 22 applied to the transparent panel 20. As described herein, the lines of adhesive 22a, 22b correspond respectively to walls 14, 16 and the line of adhesive 22c seals around the outer periphery of transparent panel 20 and a corresponding periphery of upper frame portion 12. The drum 54 is rotated generally in a direction indicated by the arrow labeled with reference numeral 58 with the resilient printing plate 52 in contact with the transparent panel 20. The transparent panel 20 is moved generally linearly in a direction indicated by the arrow labeled with reference numeral 60, which transfers the adhesive 22 to the transparent panel 20. The movement of the transparent panel 20 and the rotation of the drum 54 are coordinated for proper adhesive application. After the pattern of adhesive 22 is applied to transparent panel 20, the upper frame portion 12 and the transparent panel 20 are contacted with an aligned relationship so that the pattern of adhesive 22 is registered with the bottoms of walls 14, 16, and the adhesive 22 is cured to adhesively bond the upper frame portion 12 to the transparent panel 20. With reference to FIG. 12 and in accordance with an alternative embodiment of the invention, the pattern of adhesive 22 may be applied by flexographic printing to the upper frame portion 12 rather than to the transparent panel 20 and the two components contact to establish an adhesive bond to form multi-well test plate 10.

With reference to FIG. 12 and in accordance with yet another alternative embodiment of the invention, the pattern of adhesive 22 may be applied to the upper frame portion 12 using techniques of pad printing. An inscribed adhesive image, generally indicated by reference numeral 62, is formed in a printing plate 64 by a conventional technique. As an initial stage of adhesive application, an adhesive source 66 moved over the surface area of the printing plate 64 fills the grooves of the inscribed image 62 with adhesive 22. Excess adhesive 22 is wiped from the printing plate 64 thereby leaving adhesive 22 exclusively in the grooves of the inscribed image 62.

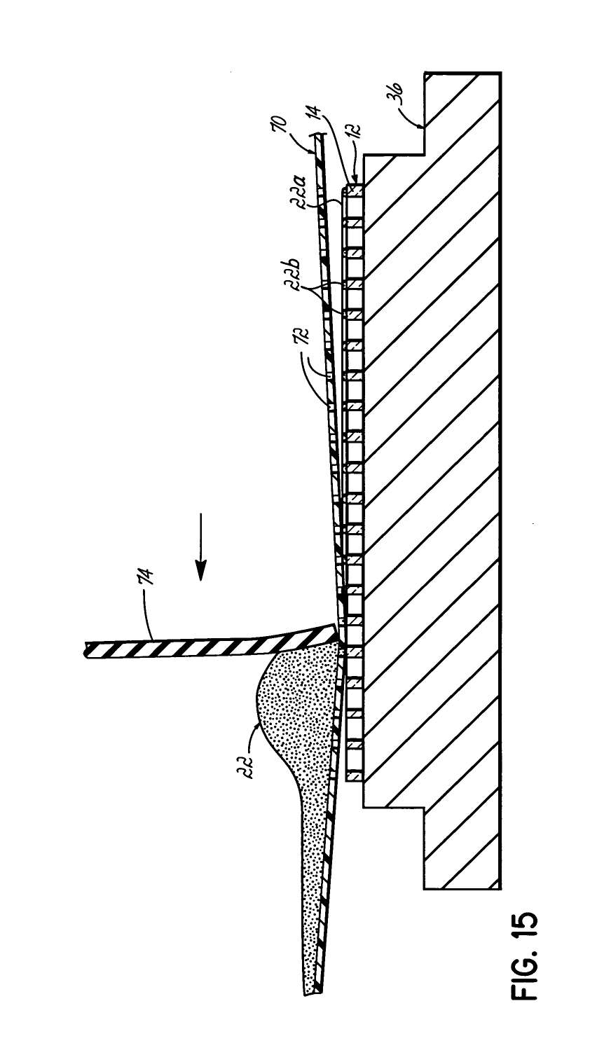

Adhesive 22 is transferred from the inscribed image 62 to a transfer pad 68 by lowering the flexible transfer pad 68 vertically downward into pressure contact with the printing plate 64. The transfer pad 68 is then raised vertically upward from the printing plate 64, having acquired adhesive 22 from the inscribed image 62, and then lowered into pressure contact with the underside of the upper frame portion 12 to effect adhesive transfer when the transfer pad 68 is lifted. The adhesive 22 is thereby transferred as a consistent layer in the pattern from the transfer pad 68 to the upper frame portion 12. The adhesive 22 on upper frame portion 12 has an appearance as in FIG. 4. The upper frame portion 12 is contacted with transparent panel 20 and the adhesive 22 is cured to adhesively bond upper frame portion 12 to the transparent panel 20. With reference to FIG. 14 and in accordance with an alternative embodiment of the invention, the pattern of adhesive 22 may be applied by pad printing to the transparent panel 20 rather than to the upper frame portion 12 and the two components contacted to establish an adhesive bond to form multi-well test plate 10.

With reference to FIG. 15 and in accordance with yet another alternative embodiment of the invention, the pattern of adhesive 22 may be applied to the upper frame portion 12 using techniques of silk screening. A screen 70, effectively defining a stencil, is contacted with, or placed proximate to, the upper frame portion 12 such that a grid of apertures 72 each extending through the screen 70 is registered with the bottoms of walls 14, 16. A squeegee or doctor blade 74 is moved across the upper surface of screen 30, which pushes screen 70 against upper frame portion 12 with line contact and forces portions of adhesive 22 through apertures 72 and onto the upper frame portion 12 leaving the grid pattern of adhesive on the bottoms of walls 14, 16 as shown in FIG. 6. During the adhesive application process, the upper frame portion 12 may be mounted on a suitable fixture 36, such as through the use of vacuum.

While the present invention has been illustrated by a detailed description of a preferred embodiment, it is not the intention of the applicants to restrict or in any way limit the scope of the appended claims to such detail. Various features of the invention may be combined in various unique and advantageous manners to achieve objectives of the invention. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicants' general inventive concept.

1. A method of making a multi-well test plate including a transparent panel and an upper frame portion with a plurality of walls defining wells arranged in a pattern, the method comprising:
dispensing a plurality of beads of an adhesive in a configuration corresponding to the pattern from an adhesive dispenser onto one of the upper frame portion and the transparent panel;
contacting the transparent panel with the upper frame portion such that the adhesive is disposed between the transparent panel and the upper frame portion; and
curing the adhesive to adhesively bond the upper frame portion and the transparent panel.

2. The method of claim 1 wherein at least two of the plurality of beads are dispensed simultaneously.

3. The method of claim 2 wherein dispensing the plurality of beads further comprises:
dispensing the at least two of the plurality of beads from corresponding number of pen transfer valves.

4. The method of claim 1 wherein dispensing the plurality of beads further comprises:
moving the adhesive dispenser in a pattern corresponding to the grid pattern while providing a flow of the adhesive to the one of the upper frame portion and the transparent panel.

5. The method of claim 1 wherein dispensing the plurality of beads is performed by robotic dispensing.

6. A method of making a multi-well test plate including a transparent panel and an upper frame portion with a plurality of walls defining wells arranged in a pattern, the method comprising:
transferring an adhesive arranged in a configuration corresponding to the pattern from a transfer member to the upper frame portion;
contacting the transparent panel with the upper frame portion such that the adhesive is disposed between the transparent panel and the upper frame portion; and
curing the adhesive to adhesively bond the upper frame portion and the transparent panel.

7. The method of claim 6 wherein the transfer member is a printing block, and transferring the adhesive further comprises:
applying an adhesive image having the configuration to the printing block;
positioning the printing block relative to the upper frame portion; and
contacting the printing block with the upper frame portion to affect adhesive transfer.

8. The method of claim 6 wherein the transfer member is a flexible transfer pad, and transferring the adhesive further comprises:
placing adhesive in grooves inscribed in the printing plate with the configuration;
contacting the printing plate with a flexible transfer pad to transfer the adhesive from the grooves to the transfer pad; and
contacting the flexible transfer pad with the upper frame portion to affect adhesive transfer.

9. The method of claim 6 wherein the transfer member is a resilient printing plate having raised lines arranged in the configuration, and transferring the adhesive further comprises:
rotating a cylindrical drum carrying the resilient printing plate on an exterior surface;
applying an adhesive to the raised lines of the resilient printing block; and
contacting the raised lines of the resilient printing block with the upper frame portion to affect adhesive transfer.

10. The method of claim 6 wherein transferring the adhesive is performed by at least one of transfer printing, flexographic printing, a silk screening process, and pad printing.

11. A method of making a multi-well test plate including a transparent panel and an upper frame portion with a plurality of walls defining wells arranged in a pattern, the method comprising:
transferring an adhesive arranged in a configuration corresponding to the pattern from a transfer member to the transparent panel by at least one of transfer printing, flexographic printing, and pad printing;
contacting the transparent panel with the upper frame portion such that the adhesive is disposed between the transparent panel and the upper frame portion; and
curing the adhesive to adhesively bond the upper frame portion and the transparent panel.

12. The method of claim 11 wherein the transfer member is a printing block, and transferring the adhesive further comprises:
applying an adhesive image having the configuration to the printing block;
positioning the printing block relative to the transparent panel; and
contacting the printing block with the transparent to affect adhesive transfer.

13. The method of claim 11 wherein the transfer member is a flexible transfer pad, and transferring the adhesive further comprises:
placing adhesive in grooves inscribed in the printing plate with the configuration;
contacting the printing plate with a flexible transfer pad to transfer the adhesive from the grooves to the transfer pad; and
contacting the flexible transfer pad with the upper frame portion to affect adhesive transfer.

14. The method of claim 11 wherein the transfer member is a resilient printing plate having raised lines arranged in the configuration, and transferring the adhesive further comprises:
rotating a cylindrical drum carrying the resilient printing plate on an exterior surface;
applying an adhesive to the raised lines of the resilient printing block; and
contacting the raised lines of the resilient printing block with the upper frame portion to affect adhesive transfer.

15. A method of making a multi-well test plate including a transparent panel and an upper frame portion with a plurality of walls defining adjacent wells and having upper and lower ends, the method comprising:
mounting the upper frame portion with the lower ends of the plurality of walls disposed adjacent a screen having apertures in a configuration corresponding to the lower ends of the plurality of walls;
urging portions of a layer of adhesive through a screen opposite to the lower ends of the plurality of walls through the apertures and onto the lower ends of the plurality of walls in the configuration;
contacting the transparent panel with the upper frame portion such that the adhesive is disposed between the transparent panel and the upper frame portion; and
curing the adhesive to adhesively bond the upper frame portion and the transparent panel.
